(19) United States
(12) Patent Application Publication
(10) Pub. No.: US 2007/0024751 A1
(43) Pub. Date: Feb. 1, 2007

(54) Digital broadcasting-receiving apparatus

(75) Inventors: Shigeo Morimoto, Tokyo (JP); Yuichi Inoue, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/434,187

(22) Filed: May 16, 2006

(30) Foreign Application Priority Data
Jul. 27, 2005 (JP) 2005-218058

(51) Int. Cl. H04N 5/445

(52) U.S. Cl. 348/563; 386/1

(57) ABSTRACT

The invention aims at providing a digital broadcasting-receiving apparatus which is not connected to a network, especially, a method of transmitting a program easy to receive, and a digital broadcasting-receiving apparatus which readily makes program update. A receiving apparatus (1) of the invention down loads an update program common to a plurality of receiving apparatuses using different control programs, and selects only a necessary module among a plurality of modules contained in the update program to rewrite the necessary module thus selected.

The present application is based on Japanese patent application No. 2005-218058, the entire contents of which are incorporated herein by reference.

### BACKGROUND OF THE INVENTION

1. Field of the Invention

The present invention relates to a digital broadcasting-receiving apparatus, and more particularly to an S-band satellite digital broadcasting-receiving apparatus which receives an update program carried on a satellite broadcasting electric wave to update a program currently used therein.

2. Description of Related Art

A television/radio receiving apparatus which is easy to carry and a broadcasting system aiming at such a portable receiving apparatus have been developed, and dedicated broadcasting programs have also started to be broadcasted.

A controller is generally built in an electronic apparatus product which is not limited by a portable broadcasting program-receiving apparatus, and a program for controlling the electronic apparatus product is stored therein. As the electronic apparatus product has further progressed in performance, the program built therein has also been complicated. A defect which was not observed in a manufacturing process may be found later in the complicated program. In this case, it is necessary to correct the program having such a defect. In addition, when a program which is convenient in use is newly developed, the new program may be distributed to users from a viewpoint of a user's service.

In the case of a personal computer (PC), the new program was formerly distributed through a floppy (registered trademark) disc (FD), a CD-ROM or the like. In recent years, however, under the circumstances in which the Internet has become popular, the new program has come to be distributed through the Internet.

In such a mobile phone and a next generation television other than the PC, an environment of communication with the network is built. Hence, a corrected program can be obtained through the network similarly to the case of the PC. This is disclosed in Japanese Patent Kokai No. 2004-320114.

In programs for the PC, the contents of corrected programs differ in a difference in version of the program. In addition, in the case of control programs for electronic apparatuses, even when the electronic apparatuses are of the same type, the control programs differ depending on the types of apparatuses. For this reason, even in the case of the program corrected in accordance with the same reason, the different corrected programs are required in correspondence to the corresponding types of apparatuses.

In the case of the PC, the next generation television, the mobile phone or the like described above, the corrected program is previously up loaded on a network server. In a state in which the down load can be made for the apparatus described above, a request to transmit the corrected program concerned is made, and the corrected program is delivered on demand. The reason why such a method can be utilized is that the bidirectional communication can be made between the above-mentioned apparatus and the server.

However, the portable digital broadcasting-receiving apparatus is not connected to the network, so that the delivery of corrected programs as described above is not possible to be made, since one way communication is only carried out, in which the portable digital broadcasting-receiving apparatus only receives electric waves transmitted via a broadcasting satellite.

For this reason, the delivery of corrected programs is carried out, such that the corrected programs are necessarily carried on broadcasting electric waves to be transmitted. In this case, however, the number of kinds of corrected programs to be transmitted increases, since receiving apparatuses are necessary to receive a different corrected program for each different maker and types. This leads to a case where an opportunity at which a program concerned can be received is a very short part of a period of time for which all programs are transmitted. In order to increase the opportunity at which the program can be received, it is necessary to increase a period of time for which all the programs are transmitted.

### SUMMARY OF THE INVENTION

In the light of the foregoing, it is an object of the present invention to provide a receiving apparatus which is not connected to a network, especially, a method of transmitting a program easy to receive, and a receiving apparatus which receives an update program to update a program.

In order to attain the above-mentioned object, according to an aspect of the present invention, there is provided a digital broadcasting-receiving apparatus including: a receiving portion for receiving an update program containing therein a common module common to a plurality of types of apparatuses, a plurality of modules prepared in correspondence to at least one type of apparatus among the plurality of types of apparatuses, and a table for indicating a correspondence between each of the plurality of types of apparatuses and each of the plurality of modules; a preservation area in which information on one type of apparatus among the plurality of types of apparatuses is preserved; a down loading portion for down loading the update program received by the receiving portion; a storage area in which a module selected among the plurality of modules contained in the update program is written; and a controlling portion for selecting a module corresponding to the information on the one type of apparatus preserved in the preservation area among the plurality of modules contained in the update program to write the module thus selected in the storage area.

According to the present invention, even when the common program common to all the types of apparatuses is down loaded, only the module necessary for the type of apparatus concerned can be rewritten. Hence, it is becomes unnecessary to prepare the individual programs for the types of apparatuses and transmit the individual programs at the different opportunities.

The controlling portion may perform a reading operation for reading out the information on the one type of apparatus from the preservation area, and a rewriting operation for rewriting the common module contained in the update program to the storage area subsequently to the reading operation, and may next perform a writing operation for writing the module corresponding to the information on the one type of apparatus to the storage area.

The controlling portion, when being instructed to receive the update program from an outside, may make the receiving portion receive the update program.

According to another aspect of the present invention, there is provided a digital broadcasting-receiving apparatus including: a receiving portion for receiving an update program containing therein a common module common to a plurality of types of apparatuses, a plurality of modules prepared in correspondence to at least one type of apparatus among the plurality of types of apparatuses, and a table for indicating a correspondence between each of the plurality of types of apparatuses and each of the plurality of modules; a preservation area in which information on one type of apparatus among the plurality of types of apparatuses is preserved; a down loading portion for down loading the update program received by the receiving portion; a storage area to which a rewrite is made in accordance with the update program; and a controlling portion for reading out the information on the one type of apparatus from the preservation area when activating the update program, for executing one module when the one module in the plurality of modules contained in the update program corresponds to the one type of apparatus, and for skipping the one module without executing the one module when the one module does not correspond to the one type of apparatus.

According to the present invention, even when one program common to all the types of apparatuses is down loaded, only the module necessary for the type of apparatus concerned can be executed. Hence, it is becomes unnecessary to prepare the individual programs for the types of apparatuses and transmit the individual programs at the different opportunities.

The controlling portion, when being instructed to receive the update program from an outside, may make the receiving portion receive the update program.

According to the present invention, it is possible to increase the number of opportunities of receiving the update program in the receiving apparatus and reduce the transmission cost because of the shortening of a period of time for which the program is transmitted.

### BRIEF DESCRIPTION OF THE DRAWINGS

FIG. 1 is a view showing a schematic construction of a receiving system according to an embodiment of the present invention;

FIG. 2 is a block diagram showing an internal configuration of a receiving apparatus according to the embodiment of the present invention;

FIG. 3 is a plan view showing details of an operation portion shown in FIG. 1;

FIG. 4 is a diagram showing a constructional example in the case where update programs are written for respective types of a plurality of receiving apparatuses made by one receiving apparatus maker, and these update programs are arranged into one program;

FIG. 5 is a diagram showing an example of a table for apparatus type information and module to be used;

FIG. 6 is a diagram showing an effect when no programs which are different among types of receiving apparatuses are transmitted, but an all apparatus type corresponding update program is transmitted;

FIGS. 7A and 7B are respectively diagrams showing an effect when no programs which are different among the types of receiving apparatuses are transmitted, but the all apparatus type corresponding update program is transmitted;

FIG. 8 is a flow chart explaining a flow of program update according to a first embodiment of a program-updating method; and

FIG. 9A is a flow chart explaining a flow of program update according to a second embodiment of a program-updating method; and

FIG. 9B is a flow chart explaining a flow in executing a program after completion of the update of the program according to the second embodiment of the program-updating method.

### DETAILED DESCRIPTION OF PREFERRED EMBODIMENTS

Hereinafter, an embodiment of the present invention will be described in detail with reference to the accompanying drawings.

(Construction of System)

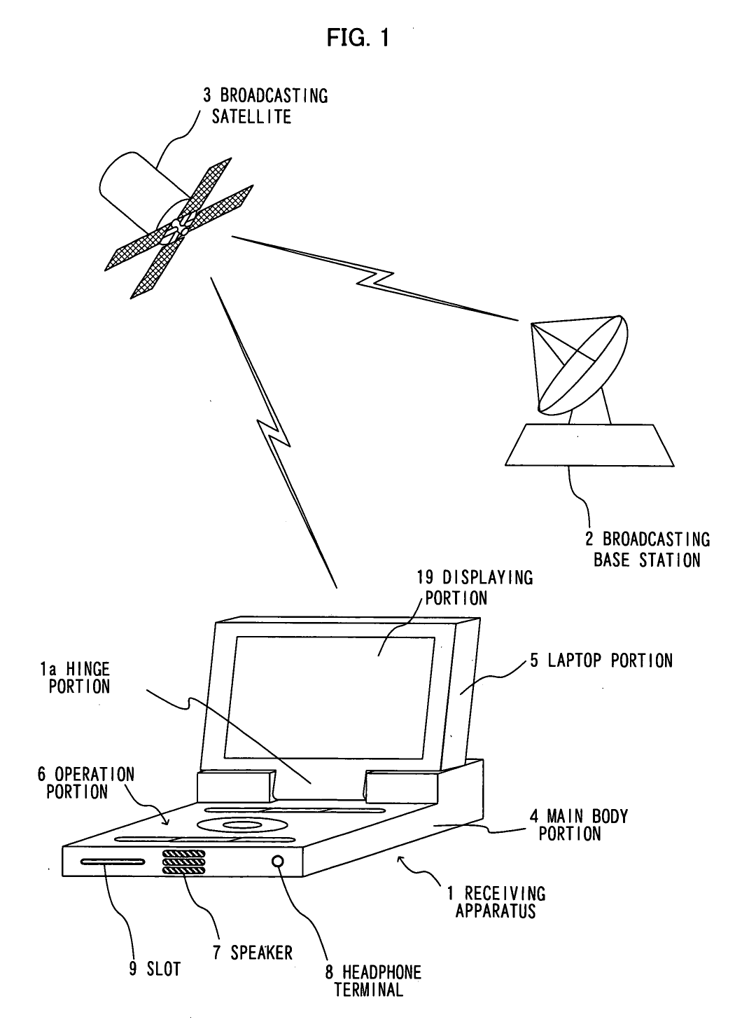

FIG. 1 shows a schematic construction of a receiving system according to an embodiment of the present invention. The receiving system is schematically constituted by a broadcasting base station 2 which is installed on the ground and which can transmit a plurality of digital broadcastings such as a television program broadcasting and a radio program broadcasting, and a receiving apparatus 1 which receives a broadcasting electric wave from the broadcasting base station 2 via a broadcasting satellite 3 located in a space.

It should be noted that while FIG. 1 shows an example when the satellite broadcasting is received, the receiving apparatus 1 of the present invention is not limited thereto. Thus, one which receives ground wave broadcastings, one which receives broadcastings through a transmission medium such as a cable, one which receives bidirectionally broadcastings, or the like may also be adopted.

With the receiving apparatus 1, a user can select a program which he/she wants to enjoy among a plurality of broadcastings, and can see and listen to the selected program. The receiving apparatus 1 includes a main body portion 4 having an antenna, an electronic circuit, and the like built therein, and a laptop portion 5 which is provided closeably in an upper portion of the main body portion 4 through a hinge portion 1a.

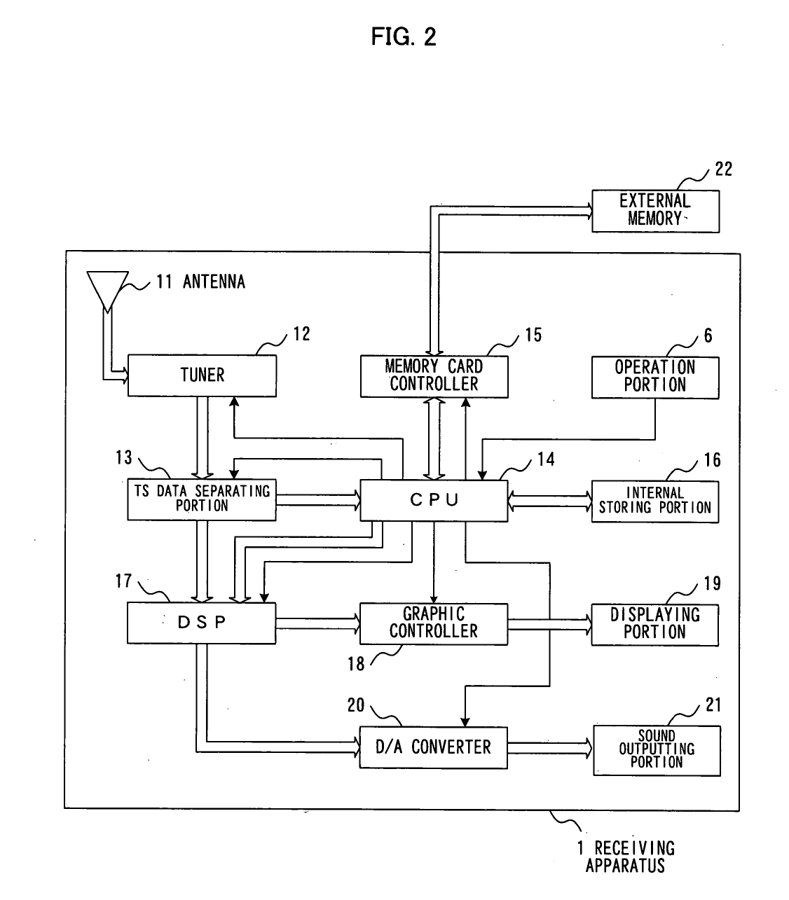

The main body portion 4 is provided with an operation portion 6 including various kinds of switches on its upper surface. Also, the main body portion 4 is provided with a speaker 7, a headphone terminal 8, and a slot 9 into which a memory card as will be described later is inserted on its front. Incidentally, the speaker 7 and the headphone terminal 8 constitute a sound-outputting portion 21 (refer to FIG. 2).

The laptop portion 5 includes a displaying portion 19 such as a liquid crystal display device, or an organic EL display device.

When the user desires to see and listen to a television program, the display portion 19 displays thereon a program image, and the sound outputting portion outputs a program sound. On the other hand, when the user desires to listen to a radio program, the sound-outputting portion 21 outputs a program sound, and at the same time, the displaying portion 19 displays thereon information or the like on the contents of the program and pieces of music being currently broadcasted. Whether a television broadcasting or a radio broadcasting is selected is determined by operating the operation portion 6.

(Internal Configuration of Receiving Apparatus 1)

FIG. 2 is a block diagram showing an internal configuration of the receiving apparatus 1 according to the present invention.

The receiving apparatus 1 includes an antenna 11, a tuner 12, a transport stream (TS) data-separating portion 13, a CPU 14, a memory card controller 15, an internal storing portion 16, a digital signal processor (DSP) 17, a graphic controller 18, a displaying portion 19, a D/A converter 20, and the sound-outputting portion 21.

The antenna 11 receives thereat a broadcasting electric wave, about a satellite broadcasting program, which is outputted from the broadcasting base station 2 and transmitted via the broadcasting satellite 3. Also, the antenna 11 converts the broadcasting electric wave received thereat into an electrical signal and transmits the resulting electrical signal to the tuner 12.

The tuner 12 selects necessary data from a digital program broadcasting signal transmitted thereto through the antenna 11, and transmits the necessary data thus selected to the TS data-separating portion 13.

The TS data-separating portion 13 separates the digital program broadcasting signal received thereat from the tuner 12 into video/sound data on a program image and a program sound, and management information data such as EPG data and management data. Also, the TS data-separating portion 13 transmits the management information data and the video/sound data to the CPU 14 and the DSP 17, respectively.

The CPU 14 manages the control for the functions in the receiving apparatus 1. Thus, the CPU 14 transmits signals to the constituent portions to instruct the constituent portions to perform the various kinds of operations, respectively. In addition, the CPU 14 performs the control for the transmission of the data during storage and reading of the received management information data in and from the internal storing portion 16 or the like.

The memory card controller 15 controls a memory card or the like as an external memory 22, and performs the reading and writing of the program data which is recorded with image and sound from and to the external memory 25.

The internal storing portion 16 is used to store a program which the CPU 14 is instructed to execute in order to drive the receiving apparatus 1, temporarily store the various kinds of parameters, the management information data, and the like which are used in the program, and store the program data which is recorded with image and sound. More specifically, a ROM, a RAM, an HDD or the like corresponds to the internal storing portion 16.

The DSP 17 executes arithmetic operation processing for the video/sound data which is received from the TS data-separating portion 13. Also, the DSP 17 transmits the video data and the sound data to the graphic controller 18 and the D/A converter 20, respectively.

The graphic controller 18 processes the video data received from the DSP 17 so that the displaying portion 19 can display thereon the resulting data. Also, the graphic controller 18 transmits the resulting data to the displaying portion 19.

The displaying portion 19 displays the video data received from the graphic controller 18 on its monitor. The image to be displayed is an image of the television program from the satellite broadcasting, character information on a sound program, information on the apparatus setting for the receiving apparatus 1, or the like.

The D/A converter 20 converts the sound data received from the DSP 17 from digital data into analog data. Also, the D/A converter 20 transmits the resulting analog sound data to the sound-outputting portion 21.

The sound-outputting portion 21 converts the analog sound signal received from the D/A converter 20 into the sound and outputs the resulting sound. The sound-outputting portion 21 includes an amplifier (not shown), the speaker 7, the headphone terminal 8, and the like.

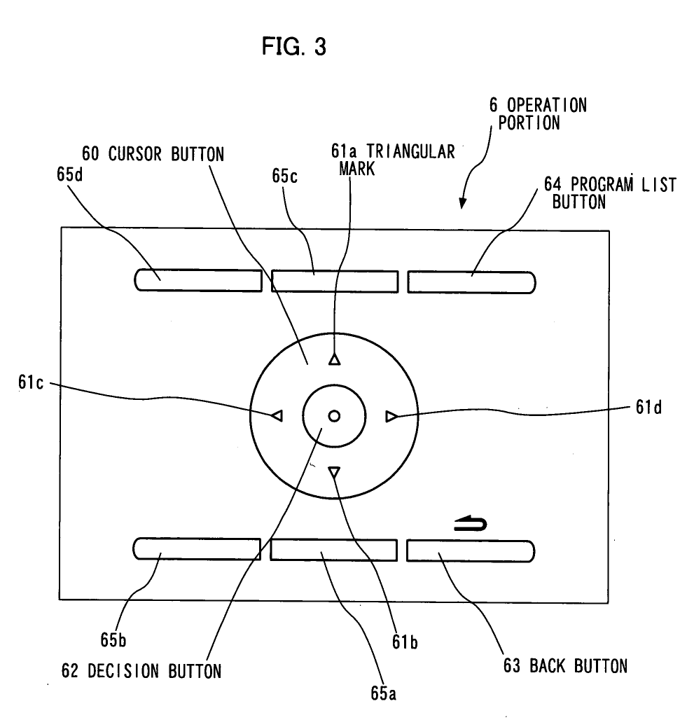

FIG. 3 shows details of the operation portion 6. The operation portion 6 includes a doughnut-like cursor button 60 having triangular marks 61a to 61d provided vertically and horizontally on its surface, a circular decision button 62 provided inside the cursor button 60, a slender back button 63, a program list button 64, and other buttons 65a to 65d. The cursor button 60, the decision button 62, and the back button 63 will be described later. In FIG. 3, reference numeral 65a designates a stop button for stop of the reproduction of the recorded data, reference numeral 65b designates a button for display of information on a data information service, reference numeral 65c designates a button for display of a memo list recorded in the memory card, and reference numeral 65d designates a quick/setting button for display of a quick menu and a setting menu.

(Operation of Receiving Apparatus 1)

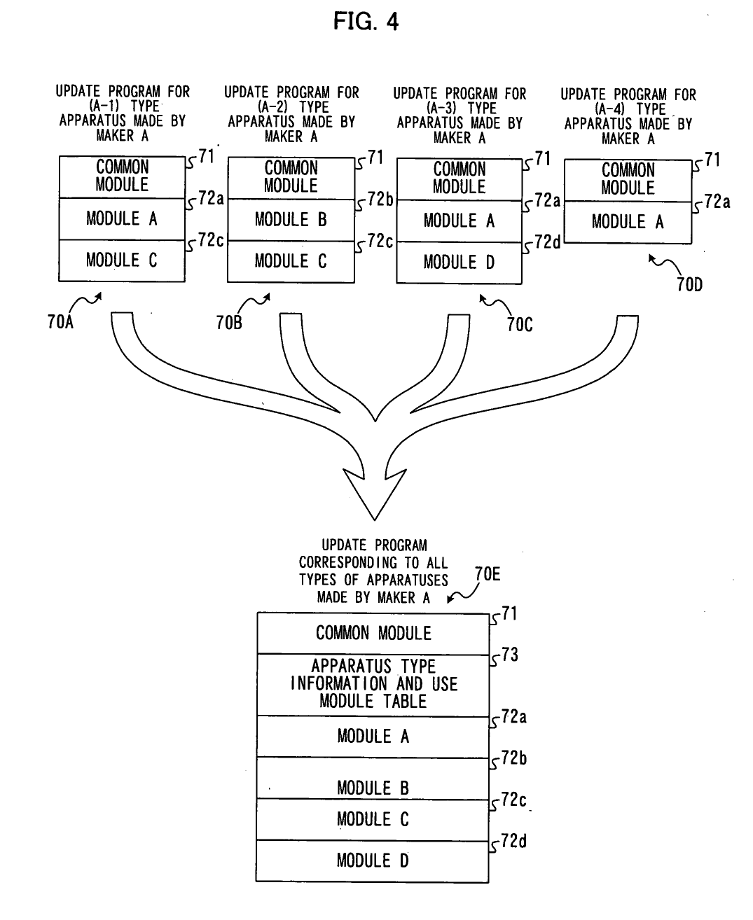

A method of delivering a corrected program to the receiving apparatus 1 according to the present invention, and a program-correcting operation for the corrected program delivered to the receiving apparatus 1 will hereinafter be described in detail with reference to FIGS. 4 to 8.

FIG. 4 is a diagram showing a constructional example in the case where update programs are written for respective types of a plurality of receiving apparatuses made by one receiving apparatus maker, and these update programs are arranged into one program.

It is assumed that a maker A as one receiving apparatus maker makes four types of receiving apparatuses from an (A-1) type of receiving apparatus to an (A-4) type of receiving apparatus. The four types of receiving apparatuses are different in part of the specification from one another. For this reason, programs having different contents and corresponding to the specifications of the four types of receiving apparatuses are necessary in updating a program.

An update program 70A for the (A-1) type of receiving apparatus contains therein a common module 71 common to all the four types of receiving apparatuses, a module A 72a, and a module C 72c. In addition, an update program 70B for the (A-2) type of receiving apparatus contains therein the common module 71, a module B 72b, and the module C 72c. Also, an update program 70C for the (A-3) type of receiving apparatus contains therein the common module 71, the module A 72a, and a module D 72d. Moreover, an update program 70D for the (A-4) type of receiving apparatus contains therein the common module 71, and the module A 72a.

In order to transmit these update programs separately from one another, when a transmission period of time per one program is held constant, a period of time is required which is four times as long as that required to transmit only one program. On the other hand, when a period of time required to transmit all the programs is held constant, the transmission period of time per one program is reduced to a quarter the period of time required to transmit only one program.

Then, one program containing all the modules contained in the update programs for the types of receiving apparatuses is made an update program which is commonly correspond to all the four types of receiving apparatuses. As a result, the resulting update program can correspond to all the receiving apparatuses made by the maker A at one transmission opportunity.

An all apparatus type corresponding program 70E which corresponds to all the four types of receiving apparatuses made by the maker A contains therein a table 73 for apparatus type information and module to be used in addition to the common module 71, the module A 72a, the module B 72b, the module C 72c, and the module D 72d. The table 73 for apparatus type information and module to be used is a table for indicating a correspondence between each of the pieces of apparatus type information on the types of receiving apparatuses to which this all apparatus type corresponding program 70E corresponds and each of the modules which the types of receiving apparatuses use respectively.

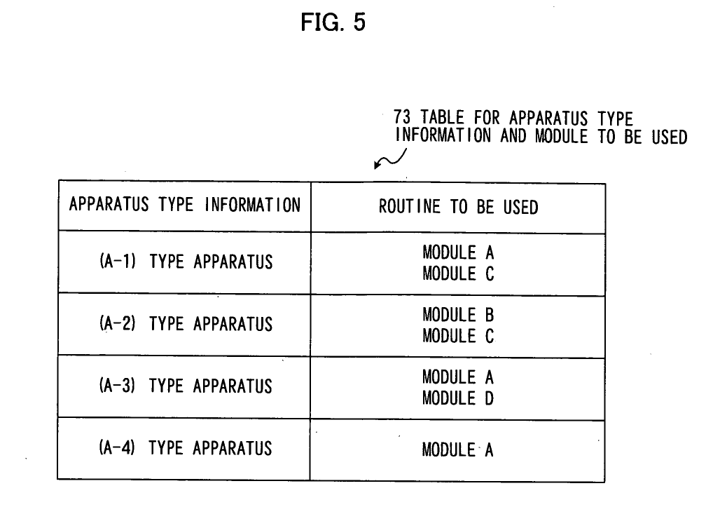

FIG. 5 is an example of the table 73 for apparatus type information and module to be used.

The apparatus type information corresponds to information such as types and ID numbers which are given to the respective types of receiving apparatuses, and forms different groups for activation programs to be used. The apparatus type information is stored in the form of non-volatile data in the internal storing portion 16. The apparatus type information stored in the internal storing portion 16, and the contents of the table 73 for apparatus type information and module to be used contained in the all apparatus type corresponding update program 70E are compared with each other, thereby identifying the modules necessary for the respective types of receiving apparatuses.

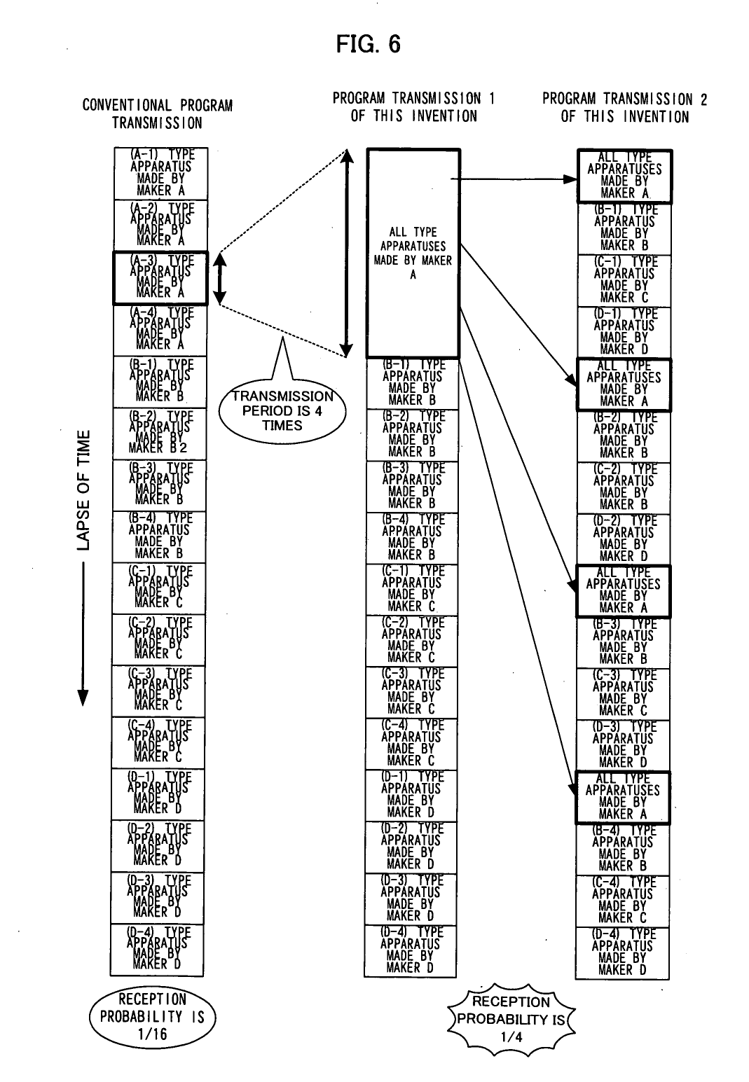

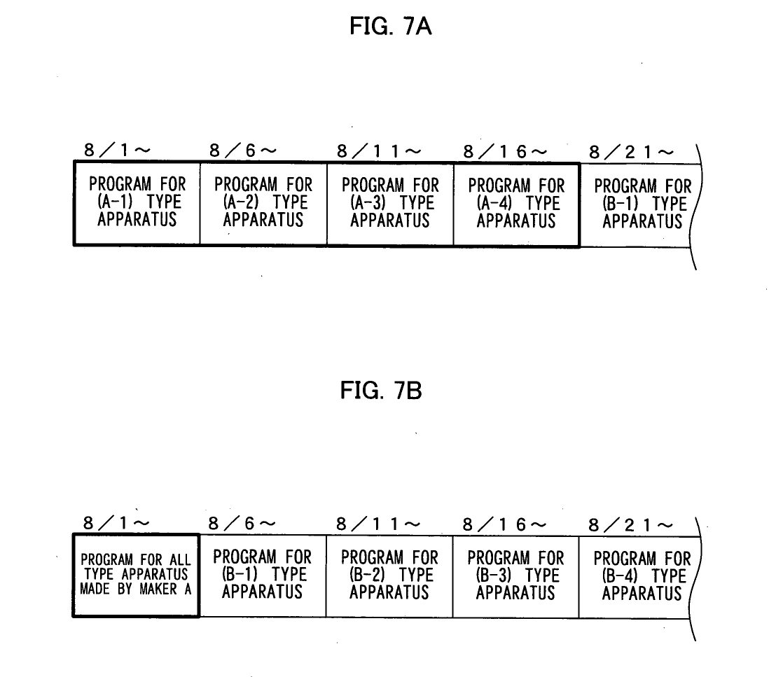

FIG. 6, and FIGS. 7A and 7B are respectively diagrams showing an effect when no programs which are different among the types of receiving apparatuses are transmitted, but the above-mentioned all apparatus type corresponding update program 70E is transmitted.

Such a mobile broadcasting-receiving apparatus as the receiving apparatus according to the present invention does not have any of communication methods other than a communication method of one-sidedly receiving a broadcasting electric wave since it cannot make the bidirectional communication with the server. For this reason, the update program needs to be transmitted so as to be carried on the broadcasting electric wave and received on the receiving apparatus side.

When there is a plurality of types of receiving apparatuses required to receive the update programs, a plurality of kinds of update programs are required by the number of types of receiving apparatuses. However, there is a limit to the information other than the broadcasting information which can be contained in the broadcasting electric wave. Hence, it is impossible to transmit many pieces of information at a time. For this reason, the individual programs must be transmitted with a period of time being partitioned.

Several methods are conceivable for how to partition a period of time required to transmit the individual programs. In this case, two methods are given as examples. One method is such that broadcastings for one day are allocated to the respective programs, and the program to be transmitted is switched over to another one at intervals of given hours.

When as shown in FIG. 6, four receiving apparatus makers make four types of receiving apparatuses each, the different corrected programs must be transmitted with a period of time being partitioned for sixteen types of receiving apparatuses in total. Thus, a transmission period of time for one corrected program is merely a sixteenth an overall transmission period of time. As a result, reception timing when viewed from one type receiving apparatus is merely a sixteenth the overall reception timing.

However, when as in the present invention, the same update program is transmitted for all the receiving apparatuses made by the maker A, all the receiving apparatuses made by the maker A can receive the update program at an appropriate time when the update program is transmitted to the receiving apparatuses made by the maker A. As a result, the transmission period of time for one corrected program, and the reception timing when viewed from any one type of receiving apparatus increase up to a quarter each.

Consequently, when this method is utilized, the user of the receiving apparatus made by the maker A is given the reception chance four times as large as that for a user of the receiving apparatus made by any other maker. As a result, the receiving apparatus made by the maker A becomes easy to receive the update program.

A second method of partitioning a transmission period of time for the individual programs is such that a given number of days are allocated to each program, only the program concerned is transmitted for the period of time corresponding thereto, and the program to be transmitted is switched over to another one at intervals of a given number of days. FIGS. 7A and 7B show an effect in this case.

As shown in FIGS. 7A and 7B, it is assumed that each program is given a transmission period of time of five days. In this case, when it is assumed that as shown in FIG. 7A, the different programs are transmitted to the four types of receiving apparatuses made by the maker A, respectively, the programs for the receiving apparatuses made by the maker A must be transmitted for twenty days in total. However, as shown in FIG. 7B, when only one program is transmitted to all the four types of recording apparatuses made by the maker A, five days are enough for a period of time required to transmit the program for the four types of receiving apparatus made by the maker A.

Consequently, when the second method is utilized, the cost required to transmit the update program written by the maker A is merely a quarter that in any other maker.

In addition to the two methods described above, such a method as to combine the two methods with each other is expected. In such a case, both the effect of an increase in reception opportunity and the effect of reduction in transmission cost are obtained.

(Operation for Program Update)

A method of updating a program to the received update program in the receiving apparatus 1 according to the present invention will hereinafter be described in detail in accordance with first and second embodiments.

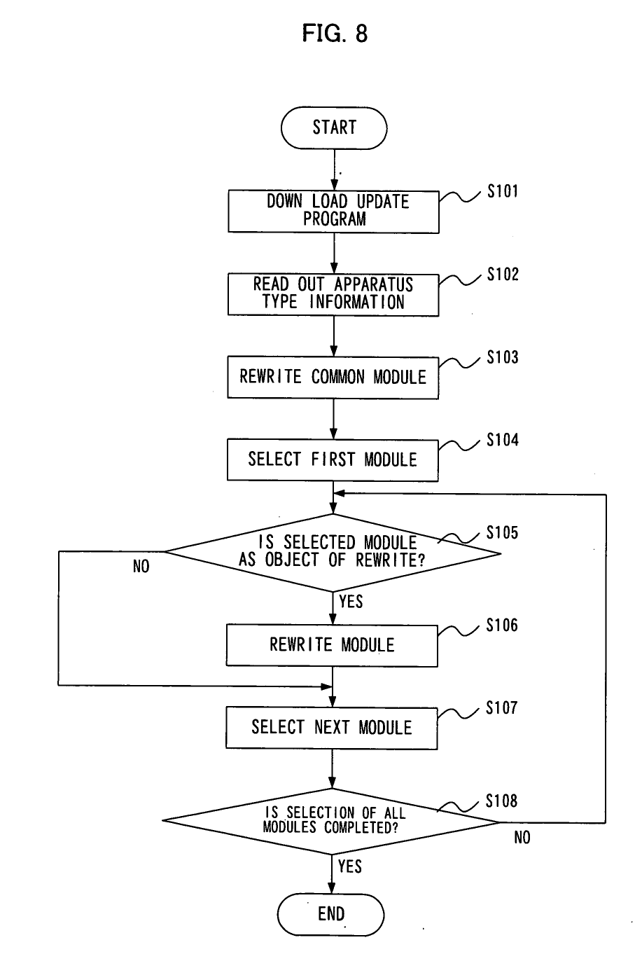

FIG. 8 is a flow chart explaining a flow of the program update according to a first embodiment of the program-updating method. At that, it is supposed that in the following processing, the CPU 14 performs an operation for the program update unless a description is especially given.

The first embodiment is such that only the necessary module is selected from the down-loaded update program and the program is then rewritten.

Firstly, the update program is down loaded (Step S101). The CPU 14 temporarily stores the update program which has been received at the tuner 12 through the antenna 11 in the internal storing portion 16 or in the external memory 22.

At that, the setting can also be made so that the update program automatically starts to be down loaded at a time point when it is recognized that the update program has been transmitted so as to be carried on the broadcasting electric wave. Alternately, the setting can also be made so that the update program only starts to be down loaded when the user issues an instruction to start the update program to be down loaded by operating the corresponding buttons of the operation portion 6.

When the setting is made so that the update program automatically starts to be down loaded, it is possible to avoid such dangerousness as to miss the update of the program. On the other hand, when the setting is made so that the update program starts to be down loaded in accordance with the instruction issued by the user, it is possible to avoid an excessive burden imposed on the CPU 14 due to the starting of the down-load in picture recording or reproducing the program.

Next, the apparatus type information is read out (Step S102). That is to say, the apparatus type information peculiar to the receiving apparatus 1 is stored in the internal storing portion 16, and the CPU 14 reads out the apparatus type information from the internal storing portion 16.

Next, the common module 71 is rewritten (Step S103). The common module 71 is a module common to all the receiving apparatuses which receive the update program each. Thus, the common module is unconditionally overwritten to the module before the update stored in a predetermined position in the internal storing portion 16 to be recorded therein.

Next, the first module is selected among a plurality of modules except for the common module (Step S104). Then, it is judged whether or not the first module thus selected is the module as an object of the rewrite (Step S105). The apparatus type information of the receiving apparatus 1 which is read out from the internal storing portion 16 in Step S102 described above, and the contents of the table 73 for apparatus type information and module to be used contained in the update program which is temporarily stored in the internal storing portion 16 or in the external memory 22 are compared with each other to judge whether or not the module concerned is the module which needs to be rewrite in the receiving apparatus 1 (Step S105). When it is judged in Step S105 that the module concerned is not the module which needs to be rewrite in the receiving apparatus 1 (S105: NO), the operation proceeds to processing in Step S107. On the other hand, when it is judged in Step S105 that the module concerned is the module which needs to be rewrite in the receiving apparatus 1 (S105: YES), the rewriting is performed for the module concerned (Step S106).

Subsequently, the next module is selected (Step S107), and it is then judged whether or not the selection of all the modules is finished (Step S108). When it is judged in Step S108 that the module which is not yet selected still remains (S108: NO), the operation returns back to the processing in Step S105 and the above-mentioned processing is repeatedly executed. On the other hand, when it is judged in Step S108 that all the modules are selected and thus there is no unselected module (S108: YES), the operation is completed.

The processing as described above is executed, whereby even when one program common to all the types of recording apparatuses is down loaded, only the module required for the type of recording apparatus concerned can be rewritten. Hence, it becomes unnecessary to prepare the individual programs for the respective types of receiving apparatuses, and transmit the individual programs at the different opportunities.

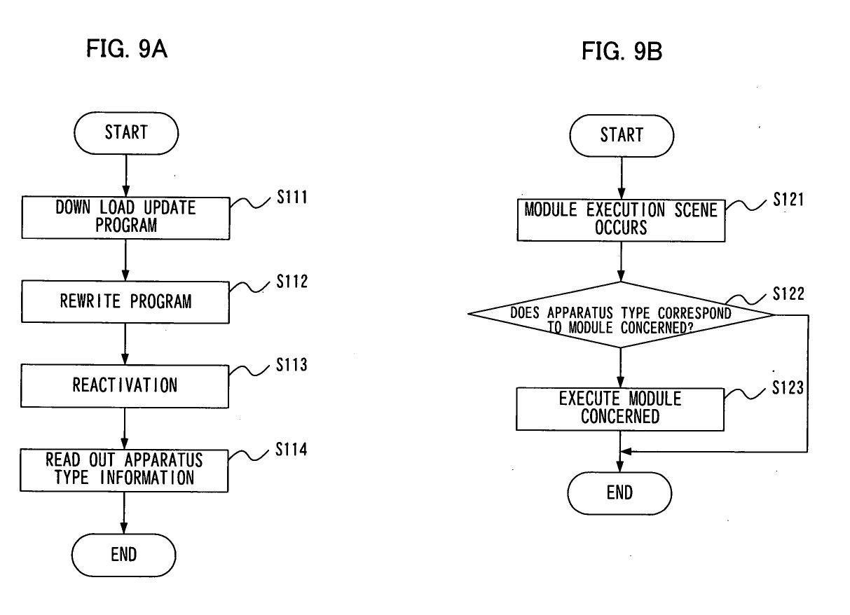

FIG. 9A is a flow chart explaining a flow of the program update according to a second embodiment of the program-updating method. FIG. 9B is a flow chart explaining a flow in executing the program after completion of the update of the program.

The second embodiment is such that all the modules in the down-loaded update program are rewritten, and it is judged whether or not each module is executed in executing the program.

Firstly, the update program is down loaded (Step S111). That is to say, the CPU 14 temporarily stores the update program which is received at the tuner 12 through the antenna 11 in the internal storing portion 16 or in the external memory 22.

In the second embodiment as well, the setting can also be made so that the update program automatically starts to be down loaded at a time point when it is recognized that the update program has been transmitted so as to be carried on the broadcasting electric wave. Alternately, the setting can also be made so that the update program only starts to be down loaded when the user issues an instruction to start the update program to be down loaded by operating the corresponding buttons of the operation portion 6.

Next, the program is rewritten (Step S112). That is to say, all the modules contained in the update program are overwritten to the modules before the update stored in predetermined positions in the internal storing portion 16 to be recorded therein, respectively.

After completion of the program rewriting, the main body portion 4 is reactivated (Step S113). Thereafter, the apparatus type information stored in the internal storing portion 16 is read out (Step S114). As a result, the update of the program is finished.

Subsequently, an operation, in executing the program, shown in FIG. 9B will be described. Firstly, a module execution scene occurs in executing an operation program (Step S121).

At this time, it is judged whether or not the type of receiving apparatus concerned is one corresponding to the module concerned (Step S122). That is to say, the apparatus type information of the receiving apparatus 1 read out in Step S114 described above, and the contents of the table 73 for apparatus type information and module to be used contained in the update program are compared with each other to judge whether or not the module concerned is one corresponding to the receiving apparatus 1 (Step S122). When it is judged in Step S122 that the module concerned is one corresponding to the receiving apparatus 1 (S122: YES), the module concerned is executed (Step S123). On the other hand, when it is judged in Step S122 that the module concerned is not one corresponding to the receiving apparatus 1 (S122: NO), no processing for the module concerned is executed.

The processing as described above is executed, whereby even when one program common to all the types of recording apparatuses is down loaded, only the module required for the type of recording apparatus concerned can be executed. Hence, it becomes unnecessary to prepare the individual programs for the respective types of receiving apparatuses, and transmit the individual programs at the different opportunities.

What is claimed is:

1. A digital broadcasting-receiving apparatus comprising:
a receiving portion for receiving an update program containing therein a common module common to a plurality of types of apparatuses, a plurality of modules prepared in correspondence to at least one type of apparatus among the plurality of types of apparatuses, and a table for indicating a correspondence between each of the plurality of types of apparatuses and each of the plurality of modules;
a preservation area in which information on one type of apparatus among the plurality of types of apparatuses is preserved;
a down-loading portion for down loading the update program received by the receiving portion;
a storage area in which a module selected among the plurality of modules contained in the update program is written; and
a controlling portion for selecting a module corresponding to the information on the one type of apparatus preserved in the preservation area among the plurality of modules contained in the update program to write the module thus selected in the storage area.

2. A digital broadcasting-receiving apparatus according to claim 1, wherein:
the controlling portion performs a reading operation for reading out the information on the one type of apparatus from the preservation area, and a rewriting operation for rewriting the common module contained in the update program to the storage area subsequently to the reading operation, and next performs a writing operation for writing the module corresponding to the information on the one type of apparatus to the storage area.

3. A digital broadcasting-receiving apparatus according to claim 1, wherein:
the controlling portion, when being instructed to receive the update program from an outside, makes the receiving portion receive the update program.

4. A digital broadcasting-receiving apparatus comprising:
a receiving portion for receiving an update program containing therein a common module common to a plurality of types of apparatuses, a plurality of modules prepared in correspondence to at least one type of apparatus among the plurality of types of apparatuses, and a table for indicating a correspondence between each of the plurality of types of apparatuses and each of the plurality of modules;
a preservation area in which information on one type of apparatus among the plurality of types of apparatuses is preserved;
a down loading portion for down loading the update program received by the receiving portion;
a storage area to which a rewrite is made in accordance with the update program; and
a controlling portion for reading out the information on one type of apparatus from the preservation area when activating the update program, for executing one module when the one module in the plurality of modules contained in the update program corresponds to the one type of apparatus, and for skipping the one module without executing the one module when the one module does not correspond to the one type of apparatus.

5. A digital broadcasting-receiving apparatus according to claim 4, wherein:
the controlling portion, when being instructed to receive the update program from an outside, makes the receiving portion receive the update program.
